(19) United States
(12) Patent Application Publication
(10) Pub. No.: US 2026/0277323 A1
(43) Pub. Date: Sep. 17, 2026

(54) METHODS AND SYSTEMS FOR HAND TRACKING IN HEAD MOUNTED DISPLAY DEVICE

(71) Applicant: SAMSUNG ELECTRONICS CO., LTD., Suwon-si (KR)

(72) Inventors: Green Rosh K S, Bangalore (IN); Vishakha SR, Bangalore (IN); Bindigan Hariprasanna PAWAN PRASAD, Bangalore (IN); Meghana SHANKAR, Bangalore (IN); Janet MARY, Bangalore (IN); Ashok GEORGE, Bangalore (IN); Anmol NAMDEV, Bangalore (IN); Shubham THAKUR, Bangalore (IN)

(73) Assignee: SAMSUNG ELECTRONICS CO., LTD., Suwon-si (KR)

(21) Appl. No.: 19/683,106

(22) Filed: May 20, 2026

Related U.S. Application Data
(63) Continuation of application No. PCT/KR2025/012414, filed on Aug. 14, 2025.

(30) Foreign Application Priority Data
Dec. 26, 2024 (IN) 202441103323

(51) Int. Cl. G06F 3/01; G06T 7/246

(52) U.S. Cl. CPC G06F 3/013; G06F 3/017; G06T 7/248; G06T 2207/20084; G06T 2207/30196

(57) ABSTRACT

A method for a hand tracking of a hand of a user in a Head Mounted Display (HMD) device, includes: detecting, during at least one current frame associated with a field-of-view (FOV) of the HMD device, a disproportionate hand movement while the hand tracking of the hand is performed; predicting, when the disproportionate hand movement is detected, a trajectory of a movement of the hand, based on a correlation between an eye gaze location of the user and a hand location of the user in one or more previous frames associated with the FOV of the HMD device; and performing, when the disproportionate hand movement is detected, the hand tracking, based on the predicted trajectory of the movement of the hand.

### CROSS-REFERENCE TO RELATED APPLICATIONS

This application is a by-pass continuation application of International Application No. PCT/KR2025/012414, filed on Aug. 14, 2025, which is based on and claims priority to Indian Patent Application No. 202441103323, filed on Dec. 26, 2024, in the Indian Intellectual Property Office, the disclosures of which are incorporated by reference herein their entireties.

### BACKGROUND

### 1. Field

The present disclosure relates to hand tracking in an electronic device such as an augmented reality (AR) device or a virtual reality (VR) device, and more particularly, to methods and systems for hand tracking in an electronic device such as a head mounted display (HMD) device worn by a user.

### 2. Description of Related Art

Hand tracking is crucial for providing immersive experiences in an electronic device such as an AR device or a VR device. As the demand for immersive experiences in these technologies intensifies, effective hand tracking has become essential for enabling intuitive interactions. Related art techniques for hand tracking are developed to function optimally in well-defined scenarios characterized by stable lighting conditions, minimal occlusion, and slow, deliberate movements. The related art techniques operate seamlessly in environments where light is constant and unobstructed, allowing for accurate detection and interpretation of hand movements.

However, the related art hand tracking techniques may struggle in dynamic environments with rapid changes in lighting, occlusion, and fast motion, resulting in unstable hand tracking and diminished user experience. For instance, in indoor settings, sudden changes in ambient lighting, such as switching lights on or off or opening curtains, can significantly impact the performance of the existing hand tracking techniques. These sudden changes in illumination can cause the camera's auto-exposure to adjust, leading to image brightness and contrast fluctuations. As a result, the related art hand tracking techniques may struggle to accurately detect and track hand key points, resulting in flickering and instability.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

According to an aspect of the disclosure, a method for a hand tracking of a hand of a user in an electronic device, includes: detecting, during at least one current frame associated with a field-of-view (FOV) of the electronic device, a disproportionate hand movement while the hand tracking of the hand of the hand is performed; predicting, during the disproportionate hand movement, a trajectory of a movement of the hand, based on a correlation between an eye gaze location of an eye gaze of the user and a hand location of the hand of the user in one or more previous frames associated with the FOV of the electronic device; and performing, during the disproportionate hand movement, the hand tracking, based on the predicted trajectory of the movement of the hand.

The predicting the trajectory of the movement of the hand may include: predicting a gaze guided hand location, based on a velocity and an acceleration of an eye movement in the at least one current frame and based on a determination of gaze guided kinematic prediction parameters; predicting a hand guided hand location with a confidence value, based on a movement of the hand in the one or more previous frames; and predicting the trajectory of the movement of the hand, based on a weighted combination of the gaze guided hand location and the hand guided hand location.

The method may further include determining the gaze guided kinematic prediction parameters by fitting kinematics parameters of movement of the hand in the one or more previous frames as a function of a kinematic parameters of the eye movement in the one or more previous frames.

The method may further include, based on the detecting the disproportionate hand movement: determining whether the eye gaze and the hand follow an expected path; and based on determining that the eye gaze and the hand follow the expected path, predicting the trajectory of the movement of the hand.

The determining whether the eye gaze and the hand follow the expected path may include: predicting the eye gaze location, based on a first acceleration and a first velocity of the eye movement in the one or more previous frames; predicting the hand location, based on a second acceleration and a second velocity of the hand movement in the one or more previous frames; determining a displacement in the predicted eye gaze location and the predicted hand location, based on a current eye gaze location and a current hand location in the at least one current frame; and determining that the eye gaze and the hand follow the expected path based on the displacement being above a first predetermined threshold.

The detecting the disproportionate hand movement may further include: determining, from the one or more previous frames, a first confidence score associated with the at least one of a plurality of environment degradations; determining, from the one or more previous frames, a second confidence score associated with a deviation in the movement of the hand from an expected path of movement of the hand; determining a final confidence score based on a combination of the first confidence score and the second confidence score; and detecting the disproportionate hand movement based on the final confidence score being above a second predetermined threshold.

The at least one of the plurality of environment degradations is a change in illumination, and wherein the determining the first confidence score may include: determining corresponding average pixel intensities for each of the one or more previous frames; determining a variation in the corresponding average pixel intensities; and determining the first confidence score corresponding to the change in illumination, based on the determined variation in the corresponding average pixel intensities.

The at least one of the plurality of environment degradations is a fast hand movement, and wherein the determining the first confidence score may include: detecting, from the one or more previous frames, a hand bounding box using a first predetermined technique; determining a sharpness of the detected hand within a bounding box using a second predetermined technique; and determining the first confidence score corresponding to the fast hand movement, based on the determined sharpness of the hand bounding box.

The at least one of the plurality of environment degradations is an occlusion, and wherein the determining the first confidence score may include: estimating, from the one or more previous frames, one or more hand key points associated with the movement of the hand based on the hand bounding box; determining whether one or more key points are occluded; and based on a determination that the one or more key points are occluded, determining the first confidence score corresponding to the occlusion.

The determining the second confidence score may include: predicting, from the one or more previous frames, the hand location using a third predefined technique; determining, using a predefined neural network (NN) model, a displacement in the predicted hand location, based on the estimated one or more hand key points indicative of the deviation in the movement of the hand from the expected path of movement of the hand; and determining the second confidence score, based on the determined displacement.

According to an aspect of the disclosure, a system for hand tracking of a hand of a user in an electronic device, includes: memory storing instructions; and at least one processor operatively coupled with the memory, wherein the instructions, when executed by the at least one the processor individually or collectively, cause the system to: detect, during at least one current frame associated with a field-of-view (FOV) of the electronic device, a disproportionate hand movement while the hand tracking of the hand is performed; predict, during the disproportionate hand movement, a trajectory of a movement of the hand, based on a correlation between an eye gaze location of an eye gaze of the user and a hand location of the hand in one or more previous frames associated with the FOV of the electronic device; and perform, during the disproportionate hand movement, the hand tracking, based on the predicted trajectory of the movement of the hand.

The instructions, when executed by the at least one the processor individually or collectively, cause the system to: predict a gaze guided hand location, based on a velocity and an acceleration of an eye movement in the at least one current frame and based on a determination of gaze guided kinematic prediction parameters; predict a hand guided hand location with a confidence value, based on a hand movement in the one or more previous frames; and predict the trajectory of the movement of the hand, based on a weighted combination of the gaze guided hand location and the hand guided hand location.

The instructions, when executed by the at least one the processor individually or collectively, cause the system to determine the gaze guided kinematic prediction parameters by fitting kinematics parameters of the hand movement in the one or more previous frames as a function of a kinematic parameters of the eye movement in the one or more previous frames.

The instructions, when executed by the at least one the processor individually or collectively, cause the system to, based on detecting the disproportionate hand movement: determine whether the eye gaze and the hand follow an expected path; and based on a determination that the eye gaze and the hand follow the expected path, predict the trajectory of the movement of the hand.

The instructions, when executed by the at least one the processor individually or collectively, cause the system to: predict the eye gaze location, based on a first acceleration and a first velocity of the eye movement in the one or more previous frames; predict the hand location, based on a second acceleration and a second velocity of the hand movement in the one or more previous frames; determine a displacement in the predicted eye gaze location and the predicted hand location based on a current eye gaze location and a current hand location in the at least one current frame; and determine that the eye gaze and the hand follow the expected path based on the displacement being above a first predetermined threshold.

The instructions, when executed by the at least one the processor individually or collectively, cause the system to: determine, from the one or more previous frames, a first confidence score associated with the at least one of a plurality of environment degradations; determine, from the one or more previous frames, a second confidence score associated with a deviation in the movement of the hand from an expected path of movement of the hand; determine a final confidence score based on a combination of the first confidence score and the second confidence score; and detect the disproportionate hand movement based on the final confidence score being above a second predetermined threshold.

The at least one of the plurality of environment degradations is a change in illumination, and wherein the instructions, when executed by the at least one the processor individually or collectively, cause the system to determine the first confidence score by: determining corresponding average pixel intensities for each of the one or more previous frames; determining a variation in the corresponding average pixel intensities; and determining the first confidence score corresponding to the change in illumination based on the determined variation in the corresponding average pixel intensities.

The at least one of the plurality of environment degradations is a fast hand movement, and wherein the instructions, when executed by the at least one the processor individually or collectively, cause the system to determine the first confidence score by: detecting, from the one or more previous frames, a hand bounding box using a first predetermined technique; determining a sharpness of the detected hand within a bounding box using a second predetermined technique; and determining the first confidence score corresponding to the fast hand movement based on the determined sharpness of the hand bounding box.

The at least one of the plurality of environment degradations is an occlusion, and wherein the instructions, when executed by the at least one the processor individually or collectively, cause the system to determine the first confidence score by: estimating, from the one or more previous frames, one or more hand key points associated with the movement of the hand based on the hand bounding box; determining whether one or more key points are occluded; and based on a determination that the one or more key points are occluded, determining the first confidence score corresponding to the occlusion.

The instructions, when executed by the at least one the processor individually or collectively, cause the system to: predict, from the one or more previous frames, the hand location using a third predefined technique; determine, using a predefined neural network (NN) model, a displacement in the predicted hand location based on the estimated one or more hand key points indicative of the deviation in the movement of the hand from the expected path of movement of the hand; and determine the second confidence score based on the determined displacement.

According to an aspect of the disclosure, provided is a computer-readable recording medium having recorded thereon a program for, when executed by a computer, performing at least one method of the embodiments of the method of operation the system in the HMD device.

To further clarify the advantages and features of the present disclosure, a more detailed description of the present disclosure will be rendered by reference to various example embodiments thereof, which are illustrated in the appended drawings. It is appreciated that these drawings depict example embodiments of the present disclosure and are therefore not to be considered limiting of its scope. The present disclosure will be described and explained with additional specificity and detail with the accompanying drawings.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example environment for implementing a system for hand tracking, according to embodiments of the present disclosure;

FIG. 2 illustrates an example system for hand tracking in a head mounted display (HMD) device, according to embodiments of the present disclosure;

FIG. 3 illustrates a block diagram of the plurality of modules for hand tracking in the HMD device, according to embodiments of the present disclosure;

FIG. 4 illustrates operations performed by the plurality of modules for hand tracking in the HMD device, according to embodiments of the present disclosure;

FIG. 5 illustrates example operations performed by the disproportionate hand movement detection module, according to the embodiments of the present disclosure;

FIG. 6 illustrates an example operations performed by the hand movement trajectory prediction module and hand tracking module, according to the embodiments of the present disclosure; and

FIG. 7 is a flow diagram of a method for hand tracking in HMD device, according to embodiments of the present disclosure.

### DETAILED DESCRIPTION

For the purpose of promoting an understanding of the principles of the present disclosure, reference will now be made to the various embodiments and specific language will be used to describe the same. No limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates. The foregoing general description and the following detailed description are explanatory of the present disclosure and are not intended to be restrictive thereof.

It is to be understood that elements in the drawings are illustrated for simplicity and may not have necessarily been drawn to scale. For example, the flow charts illustrate the method in terms of the most prominent operations or steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required”.

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, “includes”, “including”, or any other variations thereof, are intended to cover a non-exclusive inclusion, such that a process or method that comprises a list of operations (or steps) does not include only those operations (or steps) but may include other operations (or steps) not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

An objective of the present disclosure is to overcome the above-described limitations associated with hand tacking in HMD devices.

The above-mentioned objective is achieved by providing a methodology for method using stability of the eyes to compensate the instability of the hands during dynamic environment conditions. The methodology utilizes a correlation between eye and hand during an activity and use this correlation to predict an actual trajectory of the hand during unstable environment conditions such as lighting changes and fast hand motion.

Embodiments of the present disclosure will be described below in detail with reference to the accompanying drawings.

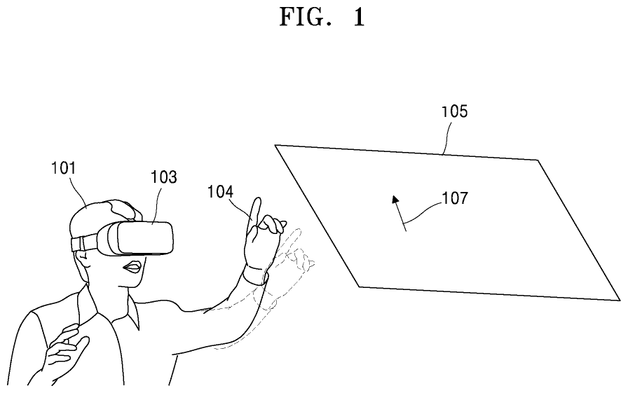

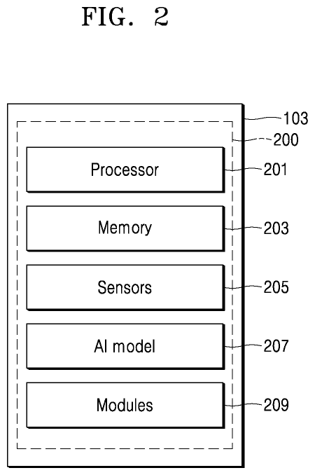

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

FIG. 1 illustrates an example environment for implementing a system for hand tracking, according to embodiments of the present disclosure. The environment may include a user 101 wearing a head mounted display (HMD) device 103 and interacting with an augmented reality (AR)/virtual reality (VR) display/environment 105 using hand movements such that a movement of a key point 107 on the AR/VR display corresponds to movement of the hand of the user 101. In an example, the HMD device 103 may be one of a virtual see-through (VST) device, VR device or AR device.

In an example, when the environment in which the HMD device 103 is used becomes unstable, or when the user's hand 104 suddenly moves rapidly, the movement of the key point 107 may not match the movement of the user's hand 104.

In an example, there may be a sudden change in the environment that may cause the key point 107 to flicker. For instance, there may be a sudden change in lighting conditions in the environment. In another instance, there may be a sudden fast movement of the user hand.

According to one or more embodiments, the HMD device 103 may include a system configured to compensate for instability of the key point rendering corresponding to the user's hand movement under unstable environment conditions such as lighting changes and rapid hand motion. Since the movements of user hands and eyes are highly correlated during an activity and eye tracking does not get impacted during the dynamic change in the environment, the system may be configured to utilize the motion of the user eye to stabilize the key point rendering during the dynamic change in the environment. The system may be configured to use a correlation between the user eye and the user hand during an activity to predict an actual trajectory of the hand and correct the erratic hand movement.

FIG. 2 illustrates an example system 200 for hand tracking in the HMD device 103, according to embodiments of the present disclosure. According to one or more embodiments of the present disclosure, the system 200 may be implemented in the HMD device 103 for hand tracking and compensating the instability of the hand key point rendering during dynamic environment conditions.

The system 200 may include a processor 201, a memory 203, one or more sensors 205, an artificial intelligence (AI) model 207, and a plurality of modules 209.

In an example, the processor 201 may be a single processing unit or a number of units, all of which could include multiple computing units. The processor 201 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 201 is configured to fetch and execute computer-readable instructions and data stored in the memory 203.

The memory 203 may include any non-transitory computer-readable medium known in the art including, for example, volatile memory or Random Access Memory (RAM), such as static random access memory (SRAM) and dynamic random access memory (DRAM), and/or non-volatile memory, such as read-only memory (ROM), erasable programmable ROM, flash memories, hard disks, optical disks, and magnetic tapes.

At least one of a plurality of operations of the system 200 may be implemented through the AI model 207. A function associated with AI may be performed through the non-volatile memory, the volatile memory, and the processor 201.

The processor 201 may include one processor or a plurality of processors. In some embodiments, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one processor or the plurality of processors control the processing of the input data in accordance with a predefined operating rule or AI model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of a desired characteristic is made. The learning may be performed in the user device itself in which AI according to an embodiment is performed, or may be implemented through a separate server/system.

In an example, the one or more sensor 205 may include at least one camera sensor configured to capture a plurality of frames associated with a field-of-view (FOV) of the HMD device 103. In an example, the one or more sensor 205 may include an RGB camera capable of obtaining a frame image including RGB information. However, the disclosure is not limited thereto, and the one or more sensor 205 may include a stereo camera including two RGB cameras, an RGB-depth camera obtaining an image including RGB information and depth information, or a black and white camera obtaining a black and white image, and is not limited to any one of these.

In an example, the one or more sensor 205 may include at least one inward facing infrared (IR) sensor for tracking eye movement of the user 101 wearing the HMD device 103. In an example, the one or more sensors 205 may provide an immersive experience to the user by simultaneously tracking the user hand movements and the user's eye gaze.

According to embodiments of the present disclosure, the AI model 207 may be or correspond to a predetermined machine learning-based model configured to perform operations of the system 200 in accordance with the embodiments of the present disclosure. The AI model 207 may be trained according to embodiments of the present disclosure. In an embodiment, the AI model 207 may be trained on the HMD device 103. In an embodiment, the AI model 207 may be trained on cloud and thereafter stored in the HMD device 103.

The AI model 207 may include a plurality of neural network layers. Each layer has a plurality of weight values and performs a layer operation through the calculation of a previous layer and an operation of a plurality of weights. Examples of neural networks include but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning technique is a method for training a predetermined target device (for example, a mobile device) using a plurality of learning data to cause, allow, or control the target device to decide or predict. Examples of learning techniques include, but are not limited to, supervised learning, unsupervised learning, semi-supervised learning, or reinforcement learning.

As mentioned above, the AI model 207 may be obtained by training. Here, “obtained by training” means that a predefined operation rule or artificial intelligence model configured to perform a desired feature (or purpose) is obtained by training a basic AI model with multiple pieces of training dataset by a training technique.

As an example, the plurality of modules 209 may be, correspond to, or include a program, a subroutine, a portion of a program, a software component, or a hardware component capable of performing a stated task or function. As used herein, the plurality of modules 209 may be implemented on a hardware component such as a server independently of other modules, or a module can exist with other modules on the same server, or within the same program. The plurality of modules 209 may be, may include, or may be implemented on a hardware component, such as processor one or more microprocessors, microcomputers, microcontrollers, digital signal processors, central processing units, state machines, logic circuitries, and/or any devices that manipulate signals based on operational instructions. The plurality of modules 209 when executed by the processor 201 may be configured to perform any of the functionalities discussed herein. In an embodiment, a subset of the plurality of modules 209 may be implemented within the user device, while another subset of the plurality of modules 209 may be implemented remotely for training the AI model 207. In another embodiment, the plurality of modules 209 may be implemented on the user device.

In an embodiment, the plurality of modules 209 may be, may correspond to, or may be implemented using the AI model 207 which may include a plurality of neural network layers.

Further, ‘learning’ may be referred to in the disclosure as a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning. At least one of a plurality of CNN, DNN, RNN, RBM models (and the like) may be implemented through an AI model.

A function associated with the AI module may be performed through the non-volatile memory, the volatile memory, and the processor. The predefined operating rule or artificial intelligence model is provided through training or learning.

The plurality of modules 209 may include a set of instructions that may be executed according to the embodiments of the present disclosure for hand tracking in the HMD device 103. The plurality of modules 209 are described in detail in the forthcoming paragraphs.

The program executed by the HMD device 103 described above herein may be implemented as a hardware component, a software component, and/or a combination of hardware components and software components. The program may be executed by any system capable of executing computer readable instructions. The software may include a computer program, code, instructions, or a combination of one or more of the foregoing, and may constitute a processing device so that the processing device may operate as desired, or may independently or collectively instruction the processing device. The software may be implemented as a computer program including instructions stored in computer-readable storage media. These recording media may be read by the computer, stored in memory, and executed by a processor. A computer-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory storage medium may include a buffer in which data is temporarily stored. Programs according to embodiments disclosed herein may be provided by being included in computer program products. Computer program products may include a software program and a computer-readable storage medium having the software program stored thereon. For example, computer program products may include a product in the form of a software program (e.g., a downloadable application) that is electronically distributed through electronic device manufacturers or electronic markets (e.g., Samsung Galaxy Store). For electronic distribution, at least a portion of the software program may be stored on a storage medium or may be created temporarily. In this case, the storage medium may be a server of a manufacturer of an electronic device, a server of an electronic market, or a storage medium of a relay server for temporarily storing a software (SW) program.

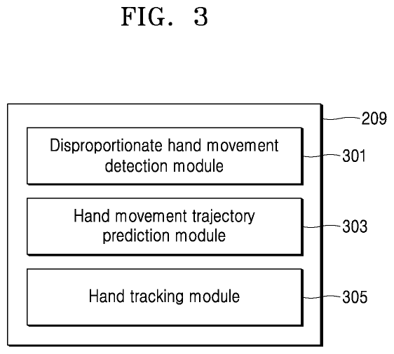

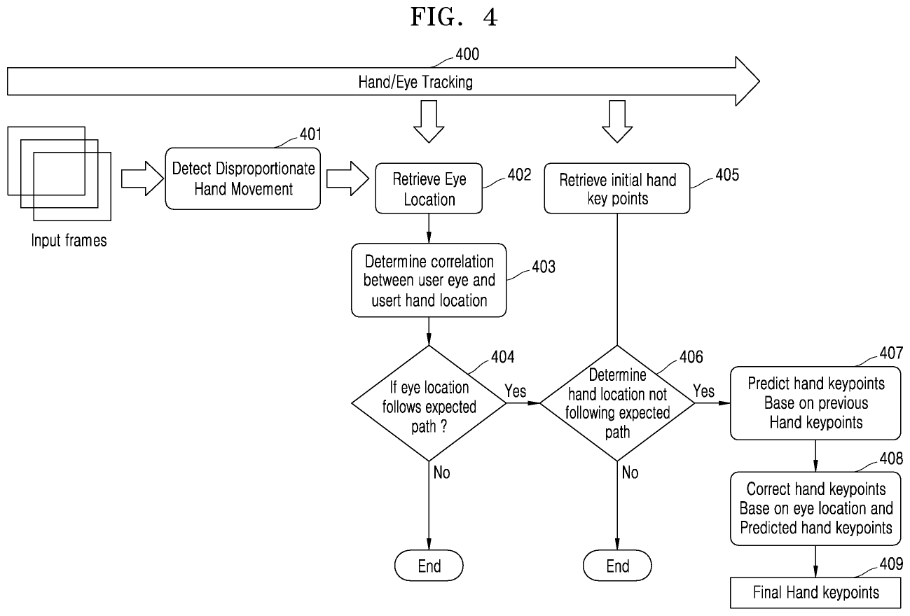

FIG. 3 illustrates a block diagram of the plurality of modules 209 for hand tracking in the HMD device 103, according to embodiments of the present disclosure. FIG. 4 illustrates operations performed by the plurality of modules 209 for hand tracking in the HMD device 103, according to embodiments of the present disclosure. Further, FIG. 3 is described with reference to FIG. 4.

Referring to FIG. 3, the plurality of modules 209 may include a disproportionate hand movement detection module 301, a hand movement trajectory prediction module 303, and a hand tracking module 305. Further, the plurality of modules 209 may be implemented in one or more predetermined sequences, according to embodiments of the present disclosure.

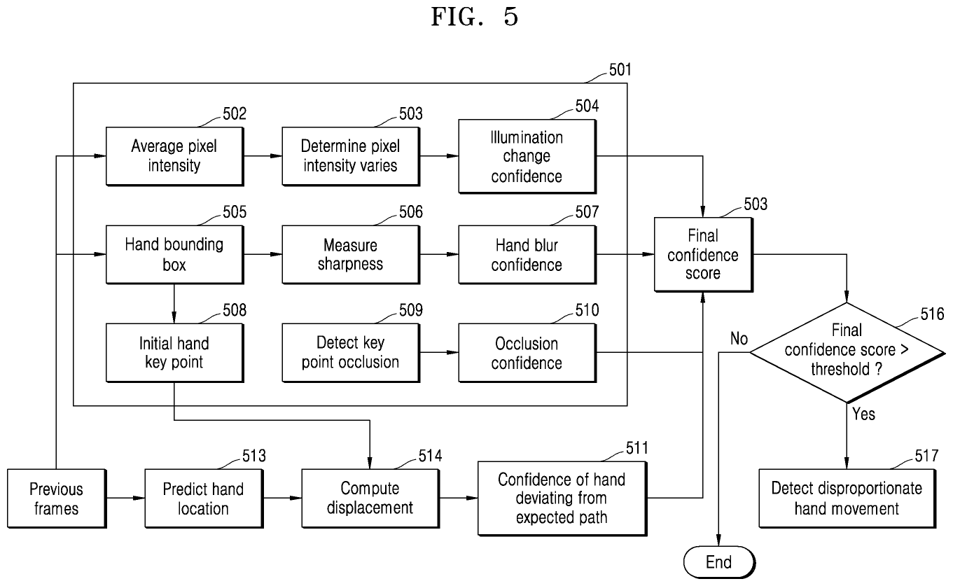

As shown in FIG. 4, at operation 400, the user eyes and the user hands are continuously tracked throughout the duration of wearing the HMD device 103. At operation 401, the HMD device 103 detects a disproportionate hand movement while performing hand tracking of a user's hand through the disproportionate hand movement detection module 301. In an example, the “disproportionate hand movement” may refer to the movement of the user's hand 104 when the surrounding environment of the HMD device 103 changes suddenly (for example, a sudden change in lighting condition), or to rapid and irregular movement of the user's hand 104. According to one or more embodiments, the disproportionate hand movement detection module 301 may be configured to detect the disproportionate hand movement using an input plurality of frames that are associated with a ‘field-of-view’ (FOV) of the HMD device 103. Further, the disproportionate hand movement detection module 301 may be configured to detect the disproportionate hand movement during at least one current frame associated with the FOV of the HMD device 103. The disproportionate hand movement detection module 301 is described in greater detail in conjunction with FIG. 5.

At operation 402, information associated with the user eye movement, during the at least one current frame, may be obtained during the continuous tracking of the user eye movement. According to one or more embodiments, information associated with the user eye movement may be retrieved through the IR sensor. In particular, the information associated with the user eye movement may be retrieved from the IR sensor that is arranged to face the user's eyes. In an example, the information associated with the user eye movement may correspond to user eye gaze location during interaction with the environment using the HMD device 103.

At operation 403, a correlation between the user eye and user hand movement is determined. In an embodiment, the correlation between the user eye and user hand movement may be determined using predetermined standard methods such as ‘cross correlation’. Since during an activity where the user eyes and the user hands are highly correlated, the determination of the correlation enables confirming whether an activity is going on which further enables using the information associated with the user eye movement to stabilize the hand key point rendering during the disproportionate user hand movement.

In an embodiment, if there is no correlation or weakly correlated between the user eye and user hand movement, it may be determined that the hand activity of the user wearing the HMD device 103 has stopped. Accordingly, the HMD device 103 may not perform correction of the hand key point using the user eye movement, and may instead use the hand key point obtained through the user hand movement.

At operation 404, whether the user eye movement is following an expected path is determined based on the user eye gaze location during an interaction with the environment using the HMD device 103. In an embodiment, the expected path to be followed by the user eye movement may be determined based on the previous frame and at least one current frame associated with the FOV of the HMD device 103. The expected path may refer to a path corresponding to a trajectory of the user's hand, the trajectory being calculated using the previous frame and at least one current frame. In an embodiment, when the user eye movement is determined to be following the expected path, information associated with user hand movement is obtained. In an embodiment, when the user eye movement is determined to be deviating from the expected path, the user eye movement may not be used to compensate the hand key point rendering corresponding to the disproportionate user hand movement.

At operation 406, based on determining the user eye movement following the expected path at operation 404, the information associated with the user hand movement 405 is obtained to determine whether the user hand movement is following the expected path. In an example, whether the user hand movement follows the expected path may be determined based on whether the user hand movement is correlated with the user eye movement. In an example, the information associated with the user hand movement may correspond to user eye movement during interaction with the environment using the HMD device 103. In an example, based on determining that the user hand movement follows the expected path, the HMD device 103 may skip additional correction of the hand key point using the user eye movement. However, during instability in the environment such as sudden illumination change or erratic hand movements, the disproportionate user hand movement may not correlate with the user eye movement. In such cases, the user hand movement may be determined to be deviating from the expected path. Thus, ‘hand key point rendering’ may be required to be stabilized corresponding to the disproportionate user hand movement.

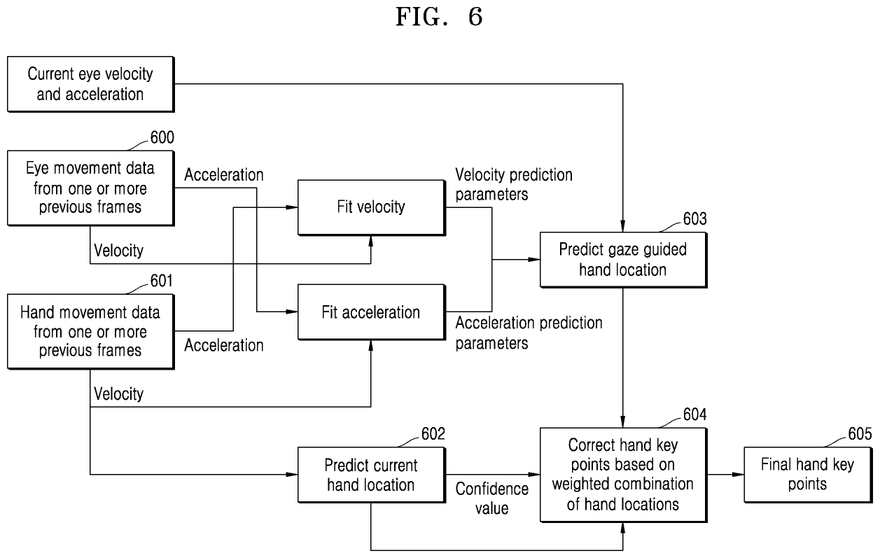

At operation 407, the HMD device 103 predicts a trajectory of movement of user hand based on the correlation between the user eye gaze location and the user hand location in one or more previous frames associated with the FOV of the HMD device 103 through the hand movement trajectory prediction module 303. In an embodiment, the hand movement trajectory is predicted during the disproportionate hand movement. The hand movement trajectory prediction module 303 is described in greater detail in conjunction with FIG. 6.

At operation 408, the hand tracking module 305 performs hand tracking in the HMD device 103, during the disproportionate hand movement, based on the predicted trajectory of the movement of the user hand. Further, the hand key point rendering is stabilized with respect to the hand tracking in the HMD device 103 based on the predicted trajectory. Further, the plurality of modules 209 will be described in detail in conjunction with subsequent figures of the present disclosure.

FIG. 5 illustrates an example operational flow of the disproportionate hand movement detection module 301, according to the embodiments of the present disclosure.

According to embodiments of the present disclosure, the module 301 is configured to detect the disproportionate hand movement while performing hand tracking of the user hand during the at least one current frame associated with the FOV of the HMD device 103.

In an embodiment, at operation 501, the module 301, at block 501, determines a first confidence score associated with the at least one of the plurality of environment degradations. In an embodiment, the first confidence score associated with the at least one of the plurality of environment degradations from one or more previous frames to the at least one current frame. According to one or more embodiments, the plurality of environment degradations may include a ‘change in illumination’, fast hand movement, and occlusion, which are further described below.

In an embodiment, when the at least one of the plurality of environment degradations is the ‘change in illumination’, the module 301 determines corresponding average pixel intensities 502 for each of the one or more previous frames. Further, the module 301 determines a variation 503 in the corresponding average pixel intensities. Furthermore, the module 301 the first confidence score corresponding to change in illumination 504 based on the determined variation in the corresponding average pixel intensities. In an embodiment, the first confidence score may increase as the change in illumination becomes larger.

In an embodiment, when the at least one of the plurality of environment degradations is the fast hand movement, the module 301 detects a hand bounding box 505 using a first predetermined technique, such as, but not limited to, a deep learning-based detector, from the one or more previous frames. The hand bounding box may be used to detect user hand. Further, the module 301 may determine sharpness 506 of the detected hand within a bounding box using a second predetermined technique such as, but not limited to, a Laplacian filter. Furthermore, the module 301 determines the first confidence score corresponding to hand blur 507 caused by fast hand movement based on the determined sharpness of the hand bounding box. In an embodiment, the first confidence score may increase as the degree of hand blur becomes larger.

In an embodiment, when the at least one of the plurality of environment degradations is the occlusion, the module 301 estimates one or more initial hand key points 508 associated with the movement of the hand based on the hand bounding box. In an embodiment, the one or more initial hand key points 508 may be estimated from the one or more previous frames. Further, the module 301 determines whether one or more key points are occluded. Furthermore, based on detecting that the one or more initial key points are occluded 509, the module 301 determines the first confidence score corresponding to the occlusion 510. In an embodiment, the first confidence score may increase as the number of occluded initial key points increases.

In an embodiment, the module 301 determines the first confidence score by aggregating confidence scores corresponding to at least one of the change in illumination, the fast hand movement, or the occlusion. Specifically, the first confidence score may be calculated as an average of the confidence scores corresponding to at least one of the change in illumination, the fast hand movement, or the occlusion; however, the present disclosure is not limited thereto.

Further, the module 301, at operation 511, determines a second confidence score associated with a deviation in the movement of the hand from an expected path of movement of the hand.

In an embodiment, the module 301 predicts the user hand location 512 using a third predefined technique such as, but not limited to, Kalman filters and particle filters. Further, the module 301 determines a displacement 514 in the predicted hand location based on the estimated one or more hand key points. According to one or more embodiments, the displacement 514 is determined using the AI model 207. In an embodiment, the AI model 207 may be a predefined ‘neural network’ (NN) model. Further, the displacement in the predicted hand location may be indicative of deviation in the movement of the hand from the expected path of movement of the hand. In an embodiment, the second confidence score may increase as the deviation in the movement from the expected path becomes larger.

Further, at operation 515, the module 301, at block 503, determines a final confidence score based on a combination of the first confidence score and the second confidence score.

At operation 516, upon the determination of the final confidence score, the module 301 compares the final confidence score with a second predetermined threshold. Furthermore, at operation 517, the module 301 detects the disproportionate hand movement when the final confidence score is determined to be the second predetermined threshold. In an embodiment, the second predetermined threshold may be a value set in advance to detect the disproportionate hand movement. As the value of the second predetermined threshold is set higher, the sensitivity to detecting the occurrence of disproportionate hand movement may increase. Conversely, as the value of the second predetermined threshold is set lower, the sensitivity to detecting the occurrence of disproportionate hand movement may decrease.

FIG. 6 illustrates an example operations performed by the hand movement trajectory prediction module 303 and hand tracking module 305, according to the embodiments of the present disclosure.

According to one or more embodiments, based on detecting the disproportionate hand movement, the module 303 determines whether the user eye gaze and the user hand follow the expected path. In an embodiment, the module 303 predicts the user eye gaze location and the user hand location 602 based on corresponding acceleration and velocity of eye movement 600 and hand movement 601 in the one or more previous frames.

Further, the module 303 determines a displacement in the predicted eye gaze location and the predicted user hand location based on a current user eye gaze location and a current user hand location 602 in the at least one current frame.

Thereafter, based on determining that the user eye gaze and the user hand follow the expected path, the module 303 triggers the module 305 for correcting hand key points as described in conjunction with FIG. 6.

According to embodiments of the present disclosure, the module 303 is configured to predict the trajectory of movement of user hand based on the correlation between the user eye gaze location and the user hand location in one or more previous frames associated with the FOV of the HMD device 103 during the disproportionate hand movement.

In an embodiment, at operation 601, the module 303 predicts a gaze guided hand location 603 based on velocity and acceleration of eye movement in the at least one current frame and determination of gaze guided kinematic prediction parameters. According to one or more embodiments, the gaze guided kinematic prediction parameters are determined by fitting kinematics parameters of hand movement, such as hand velocity and hand acceleration, in the one or more previous frames as a function of a kinematic parameters of eye movement, such as eye velocity and eye acceleration in the one or more previous frames.

In an embodiment, at operation 602, the module 303 predicts a hand location with a confidence value (c) based on the hand movement in the one or more previous frames. In an embodiment, the hand location at operation 602 may refer to a hand guided hand location. Further, at operation 604, the module 305 determines a weighted combination of the gaze guided hand location 603 and the hand guided hand location 602. According to one or more embodiments, the weighted combination may be determined using the equation (1) below:

$$Weighted combination = ( c * hand guided hand location ) + ( ( 1 - c ) * eye guided hand location ) \qquad ( 1 )$$

In an embodiment, the module 303 may predict the user gaze location and user hand location based on one or more previous frames, in response to detecting a disproportionate hand movement in FIG. 5.

The module 303 may detect the current user gaze location and the user hand location from at least one current frame. The module 303 may determine a displacement between the predicted user gaze location and the current user gaze location, and may set the confidence value (c) to 1 when the displacement exceeds a first predetermined threshold. In an embodiment of the present disclosure, the first predetermined threshold is a value configured to represent the reliability of the user's eye movement, and the smaller the first predetermined threshold is set, the higher the reliability of the user's eye movement may be. The module 303 may determine a displacement between the predicted hand position 602 and the current hand position of the user, and may set the confidence value (c) to 1 when the displacement is smaller than a third predetermined threshold.

The module 303 may set the confidence value (c) to approach 0 as the amount by which the displacement exceeds the third predetermined threshold increases. In an embodiment, the third predetermined threshold is a value configured to represent the degree to which the user eye movement is reflected in the correction of hand key points when a disproportionate hand movement is detected. The smaller the third predetermined threshold is set, the more the user eye movement may be reflected in the correction of the hand key points.

The module 303 may predict a gaze guided hand location 603 in at least one current frame based on a correlation between the user gaze position and hand position in one or more previous frames.

Furthermore, at operation 604, the module 305 may compensate for disproportionate user hand movement based on the weighted combination of the hand guided hand location 602 and the predicted gaze guided hand location 603. The module 305 may predicts the trajectory of the movement of the user hand based on the weighted combination of the gaze guided hand location 603 and the hand guided hand location 602.

Finally, the module 305 performs the hand tracking in the HMD device 103 during the disproportionate hand movement based on the predicted trajectory of the movement of the user hand. The module 305 may extract final hand key points 605 from the predicted trajectory of the movement of the user hand.

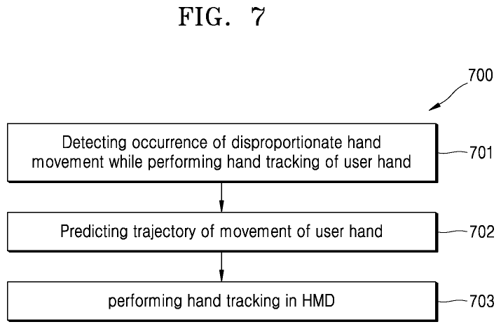

FIG. 7 is a flow diagram of a method 700 for hand tracking in HMD device 103, according to embodiments of the present disclosure. The method 700 includes a series of operations 701 through 703 executed by one or more components of the HMD device 103, in particular the processor 201.

At operation 701, the processor 201 detects the disproportionate hand movement while performing hand tracking of the user hand. In an embodiment, the disproportionate hand movement is detected during at least one current frame associated with the FOV of the HMD device 103.

In an embodiment, detecting the disproportionate hand movement comprises determining the first confidence score associated with the at least one of the plurality of environment degradations, determining the second confidence score associated with a deviation in the movement of the hand from the expected path of movement of the hand, determining the final confidence score based on a combination of the first confidence score and the second confidence score, and detecting the disproportionate hand movement when the final confidence score is above a second predetermined threshold.

In an embodiment, when the at least one of the plurality of environment degradations is change in illumination, determining the first confidence score comprises determining corresponding average pixel intensities for each of the one or more previous frames, determining a variation in the corresponding average pixel intensities, and determining the first confidence score corresponding to change in illumination based on the determined variation in the corresponding average pixel intensities.

In an embodiment, when the at least one of the plurality of environment degradations is fast hand movement, determining the first confidence score comprises detecting, from the one or more previous frames, a hand bounding box using the first predetermined technique, determining sharpness of the detected hand within a bounding box using the second predetermined technique, and determining the first confidence score corresponding to the fast hand movement based on the determined sharpness of the hand bounding box.

In an embodiment, when the at least one of the plurality of environment degradations is occlusion, determining the first confidence score comprises estimating, from the one or more previous frames, one or more hand key points associated with the movement of the hand based on the hand bounding box, determining whether the one or more key points are occluded, and based on determining that the one or more key points are occluded, determining the first confidence score corresponding to the occlusion.

At operation 702, the processor 201 predicts the trajectory of movement of user hand. In an embodiment, the prediction is based on the correlation between the user eye gaze location and the user hand location in the one or more previous frames associated with the FOV of the HMD device 103. In an embodiment, the trajectory of movement of user hand is predicted during the disproportionate hand movement.

In an embodiment, predicting the trajectory of movement of user hand comprises predicting a gaze guided hand location based on velocity and acceleration of eye movement in the at least one current frame and determination of gaze guided kinematic prediction parameters, predicting a hand guided hand location with a confidence value based on the hand movement in the one or more previous frames, and predicting the trajectory of the movement of the user hand based on a weighted combination of the gaze guided hand location and the hand guided hand location.

At operation 703, the processor 201 performing hand tracking in the HMD device 103 during the disproportionate hand movement based on the predicted trajectory of the movement of the user hand.

The systems and methods described herein use guidance from accurate eye movement to fix the instability of the hands in scenarios such as fast hand movements, change in illumination or occluded hand key point. Further, the methods described herein improve user experience by considerably improving hand key point stability corresponding to user hand movement in instable environment. Furthermore, the systems and methods described herein improve the accuracy of hand tracking in low-light or scenarios where the ambient light changes. Furthermore, the systems and methods described herein reduce the effect of hand jitters on the accuracy of hand tracking.

In the present disclosure, unless specifically stated otherwise, the use of the singular includes the plural, and the use of “or” means “and/or.” Furthermore, the use of the terms “including” or “having” is not limiting. Any range described herein will be understood to include the endpoints and all values between the endpoints. Features of the disclosed embodiments may be combined, rearranged, omitted, etc., within the scope of the disclosure to produce additional embodiments. Furthermore, certain features may sometimes be used to advantage without a corresponding use of other features.

While example embodiments have been presented in the foregoing detailed description, a vast number of variations exist.

What is claimed is:

1. A method for a hand tracking of a hand of a user in a Head Mounted Display (HMD) device, the method comprising:
detecting, during at least one current frame associated with a field-of-view (FOV) of the HMD device, a disproportionate hand movement while the hand tracking of the hand is performed;
predicting, when the disproportionate hand movement is detected, a trajectory of a movement of the hand, based on a correlation between an eye gaze location of the user and a hand location of the user in one or more previous frames associated with the FOV of the HMD device; and
performing, when the disproportionate hand movement is detected, the hand tracking, based on the predicted trajectory of the movement of the hand.

2. The method of claim 1, wherein the predicting the trajectory of the movement of the hand comprises:
predicting a gaze guided hand location, based on a velocity and an acceleration of an eye movement in the at least one current frame and based on a determination of gaze guided kinematic prediction parameters;
predicting a hand guided hand location with a confidence value, based on a movement of the hand in the one or more previous frames; and
predicting the trajectory of the movement of the hand, based on a weighted combination of the gaze guided hand location and the hand guided hand location.

3. The method of claim 2, further comprising determining the gaze guided kinematic prediction parameters by fitting kinematics parameters of movement of the hand in the one or more previous frames as a function of a kinematic parameters of the eye movement in the one or more previous frames.

4. The method of claim 3, wherein the method further comprises, based on the detecting the disproportionate hand movement:
determining whether the eye gaze follow an expected path; and
based on determining that the eye gaze follow the expected path, predicting the trajectory of the movement of the hand.

5. The method of claim 4, wherein the determining whether the eye gaze and the hand follow the expected path comprises:
predicting the eye gaze location, based on acceleration and velocity of the eye movement in the one or more previous frames;
determining a displacement in the predicted eye gaze location based on a current eye gaze location in the at least one current frame; and
determining that the eye gaze follow the expected path based on the displacement being below a first predetermined threshold.

6. The method of claim 5, wherein the detecting the disproportionate hand movement comprises:
determining, from the one or more previous frames, a first confidence score associated with the at least one of a plurality of environment degradations;
determining, from the one or more previous frames, a second confidence score associated with a deviation in the movement of the hand from an expected path of movement of the hand;
determining a final confidence score based on a combination of the first confidence score and the second confidence score; and
detecting the disproportionate hand movement based on the final confidence score being above a second predetermined threshold.

7. The method of claim 6, wherein the at least one of the plurality of environment degradations is a change in illumination, and
wherein the determining the first confidence score comprises:
determining corresponding average pixel intensities for each of the one or more previous frames;
determining a variation in the corresponding average pixel intensities; and
determining the first confidence score corresponding to the change in illumination, based on the determined variation in the corresponding average pixel intensities.

8. The method of claim 7, wherein the at least one of the plurality of environment degradations is a fast hand movement, and
wherein the determining the first confidence score comprises:
detecting, from the one or more previous frames, a hand bounding box using a first predetermined technique;
determining a sharpness of the detected hand within a bounding box using a second predetermined technique; and
determining the first confidence score corresponding to the fast hand movement, based on the determined sharpness of the hand bounding box.

9. The method of claim 8, wherein the at least one of the plurality of environment degradations is an occlusion, and
wherein the determining the first confidence score comprises:
estimating, from the one or more previous frames, one or more hand key points associated with the movement of the hand based on the hand bounding box;
determining whether one or more key points are occluded; and
based on a determination that the one or more key points are occluded, determining the first confidence score corresponding to the occlusion.

10. The method of claim 9, wherein the determining the second confidence score comprises:
predicting, from the one or more previous frames, the hand location using a third predefined technique;
determining, using a predefined neural network (NN) model, a displacement in the predicted hand location, based on the estimated one or more hand key points indicative of the deviation in the movement of the hand from the expected path of movement of the hand; and
determining the second confidence score, based on the determined displacement.

11. A system for hand tracking of a hand of a user in a Head Mounted Display (HMD) device, the system comprising:
memory storing instructions; and
at least one processor operatively coupled with the memory,
wherein the instructions, when executed by the at least one the processor individually or collectively, cause the system to:
detect, during at least one current frame associated with a field-of-view (FOV) of the HMD device, a disproportionate hand movement while the hand tracking of the hand is performed;
predict, when the disproportionate hand movement is detected, a trajectory of a movement of the hand, based on a correlation between an eye gaze location of the user and a hand location of the user in one or more previous frames associated with the FOV of the HMD device; and
perform, when the disproportionate hand movement is detected, the hand tracking, based on the predicted trajectory of the movement of the hand.

12. The system of claim 11, wherein the instructions, when executed by the at least one the processor individually or collectively, cause the system to:
predict a gaze guided hand location, based on a velocity and an acceleration of an eye movement in the at least one current frame and based on a determination of gaze guided kinematic prediction parameters;
predict a hand guided hand location with a confidence value, based on a movement of the hand in the one or more previous frames; and
predict the trajectory of the movement of the hand, based on a weighted combination of the gaze guided hand location and the hand guided hand location.

13. The system of claim 12, wherein the instructions, when executed by the at least one the processor individually or collectively, cause the system to determine the gaze guided kinematic prediction parameters by fitting kinematics parameters of the hand movement in the one or more previous frames as a function of a kinematic parameters of the eye movement in the one or more previous frames.

14. The system of claim 13, wherein the instructions, when executed by the at least one the processor individually or collectively, cause the system to, based on detecting the disproportionate hand movement:
determine whether the eye gaze follow an expected path; and
based on a determination that the eye gaze follow the expected path, predict the trajectory of the movement of the hand.

15. The system of claim 14, wherein the instructions, when executed by the at least one the processor individually or collectively, cause the system to:
predict the eye gaze location, based on a first acceleration and a first velocity of the eye movement in the one or more previous frames;
predict the hand location, based on a second acceleration and a second velocity of the hand movement in the one or more previous frames;
determine a displacement in the predicted eye gaze location and the predicted hand location based on a current eye gaze location and a current hand location in the at least one current frame; and
determine that the eye gaze and the hand follow the expected path based on the displacement being above a first predetermined threshold.

16. The system of claim 11, wherein the instructions, when executed by the at least one the processor individually or collectively, cause the system to:
determine, from the one or more previous frames, a first confidence score associated with the at least one of a plurality of environment degradations;
determine, from the one or more previous frames, a second confidence score associated with a deviation in the movement of the hand from an expected path of movement of the hand;
determine a final confidence score based on a combination of the first confidence score and the second confidence score; and
detect the disproportionate hand movement based on the final confidence score being above a second predetermined threshold.

17. The system of claim 16, wherein the at least one of the plurality of environment degradations is a change in illumination, and
wherein the instructions, when executed by the at least one the processor individually or collectively, cause the system to determine the first confidence score by:
determining corresponding average pixel intensities for each of the one or more previous frames;
determining a variation in the corresponding average pixel intensities; and
determining the first confidence score corresponding to the change in illumination based on the determined variation in the corresponding average pixel intensities.

18. The system of claim 16, wherein the at least one of the plurality of environment degradations is a fast hand movement, and
wherein the instructions, when executed by the at least one the processor individually or collectively, cause the system to determine the first confidence score by:
detecting, from the one or more previous frames, a hand bounding box using a first predetermined technique;
determining a sharpness of the detected hand within a bounding box using a second predetermined technique; and
determining the first confidence score corresponding to the fast hand movement based on the determined sharpness of the hand bounding box.

19. The system of claim 18, wherein the at least one of the plurality of environment degradations is an occlusion, and
wherein the instructions, when executed by the at least one the processor individually or collectively, cause the system to determine the first confidence score by:
estimating, from the one or more previous frames, one or more hand key points associated with the movement of the hand based on the hand bounding box;
determining whether one or more key points are occluded; and
based on a determination that the one or more key points are occluded, determining the first confidence score corresponding to the occlusion.

20. A non-transitory computer-readable recording medium having recorded thereon a program for, when executed by a computer, performing the method of claim 1.
